(19) United States
(12) Patent Application Publication
(10) Pub. No.: US 2010/0024031 A1
(43) Pub. Date: Jan. 28, 2010

(54) System and method for transforming hierarchical objects

(75) Inventors: Aidan Eli Shribman, Tel-Aviv (IL); Nadav Helfman, Binyamina (IL); Liad Barel, Tel-Aviv (IL)

Correspondence Address: Soroker-Agmon, Advocates and Patent Attorneys for;SAP Global IP, Nolton House, Shenkar Street No. 14, Herzeliya Pituach, 46725, IL

(73) Assignee: SAP Portals Israel Ltd, Ra'anana (IL)

(21) Appl. No.: 12/494,309

(22) Filed: Jun. 30, 2009

Related U.S. Application Data
(63) Continuation-in-part of application No. 12/178,676, filed on Jul. 24, 2008.

(51) Int. Cl. G06F 17/30; H04L 9/32; G06F 21/00

(52) U.S. Cl. 726/18; 707/103 Y; 707/E17.005

(57) ABSTRACT

A method and apparatus for configuring a device, by receiving or creating a hierarchical object controlling the configuration of the device, deriving a set of commands relevant to the hierarchical object, receiving a string from a command line interface, parsing the siring into a command in accordance with the relevant set of commands, and executing the command thus manipulating the hierarchical object.

### RELATED APPLICATIONS

The present application claims the benefit under 35 U.S.C. §120 to, and is a continuation in part of application Ser. No. 12/178,676 filed Jul. 24, 2008, the full contents of which are incorporated herein by reference.

### TECHNICAL FIELD

The present disclosure relates to object management in general, and to a method and apparatus for deriving a command line interface for configuring objects, in particular.

### BACKGROUND

Command line interface (CLI) is a mechanism for interacting with a computer operating system, software, object or another entity, by typing textual commands to perform specific tasks rather than using a graphical user interface. Typically, instructing a computer to perform a given task using a command line is referred to as “entering” a command. The system waits for the user to conclude the submission of the text command by pressing a particular key, usually the “Enter” key. A command-line interpreter then receives, analyses, and executes the requested command, for example changing the configuration of an object. Upon completion, the command interpreter may return output to the user in the form of text lines on the CLI. This output may be an answer if the command was a question, or otherwise a summary of the operation, whether it was successful or not.

A CLI is often used whenever a large vocabulary of commands or queries, coupled with a wide or arbitrary range of options, can be entered more rapidly as text than with a pure graphic user interface (GUI). This is typically the case with operating system command shells or appliance TELNET-based command line interfaces. CLI is also useful when scripting or automation for automatically configuring objects is required.

Configuration of objects generally refers to assigning specific values to specific attributes of the object. Configuring objects is a common task required in many areas, such as but not limited to network device configuration, or configuration of device landscapes. In such environments, the actual devices may be represented by software objects, such that manipulating the software objects changes the configuration of the physical device. Since the underlying devices may be complex, so are their configurations. Further, the internal structure of the device which is to be configured may evolve over the life cycle of the device's development. Typically such devices support a Command Line Interface (CLI) as an interactive user interface.

The situation is not simpler when hierarchical objects are involved. In some systems, one or more attributes of the device may be grouped, and arranged in a “sub-object” of the associated object.

In traditional systems, a CLI is specifically developed for each underlying device. However, development of such a CLI and ongoing maintenance thereof, such that it remains consistent with the evolving configuration object requires a continuous significant effort.

Another method relates to using XML description files that map between CLI commands and operations. Using this method may save the cost of CLI development, as commands can be added to the XML rather than having to implemented them in a programming language. Further, the XML schema can be used for quick validation of the definition. Although such methods may reduce the effort per command, each and every command in the command set must still be hand crafted within the XML. In addition, using XML simplifies the command definition, but at the cost of reduced flexibility, relatively to using a fully fledged programming language API (such as Java or C++).

There is thus a need in the art for a method and apparatus for efficiently providing command line interface for configuring objects, and in particular hierarchical objects.

### SUMMARY

A method and apparatus for automatically providing a command line interlace for hierarchical objects.

In accordance with a first aspect of the disclosure, there is thus provided a method for manipulating a hierarchical object, comprising: receiving or creating a hierarchical object; deriving a set of commands relevant to the hierarchical object; receiving a string from a command line interface; parsing the string into a command in accordance with the relevant set of commands; and executing the command thus manipulating the hierarchical object. Within the method, the hierarchical object optionally controls a configuration of a network appliance, a configuration of a physical device, or a configuration of an application. The method can further comprise retrieving from a storage device a description of the hierarchical object or storing in a storage device a description of the manipulated hierarchical object. Within the method, the hierarchical object optionally has members of types selected from the group consisting of: an attribute, a node wherein a node comprises further nodes or attributes, and a list comprises node elements of one type. Within the method, the command for manipulating the hierarchical object optionally enables addition, deletion or modification of a member of the hierarchical object. Within the method, the command for manipulating the hierarchical object optionally enables drilling down into a sub-object of the hierarchical object.

In accordance with another aspect of the disclosure, there is thus provided an apparatus for manipulating a hierarchical object, comprising components executed by a computing platform, the apparatus comprising: a command line interface manager for creating or loading the hierarchical object; a command deriving component for automatically deriving a set of commands, based on the hierarchical object; an input/output device controller for receiving input from an input device and sending output to an output device; a parser for parsing the command; a hierarchy object manager component for manipulating the hierarchical object by executing the command; and a session manager for managing an interactive or batch session of the apparatus in which the hierarchical object is manipulated. Within the apparatus, the hierarchical object optionally controls a configuration of a network appliance, a configuration of a physical device, or a configuration of an application. The apparatus can further comprise a default commands and special keys handler for implementing default commands. The apparatus can further comprise a history manager for storing and manipulating previous commands entered by a user of the apparatus. The apparatus can further comprise a terminal manager for receiving and sending input and output streams to and from a second computing platform which connects to the computing platform. The apparatus can further comprise a login authentication manager for managing machine authentication, login state of a user, and password management of a user. The apparatus can further comprise a general manager for providing automatic completion of commands, or listing commands according to a context.

In accordance with yet another aspect of the disclosure there is thus provided a method for manipulating a hierarchical object, comprising: receiving or creating a hierarchical object controlling the configuration of a physical device, the configuration of a network appliance, or the configuration of an application, the hierarchical object comprising members of types selected from the group consisting of an attribute, a node wherein a node comprises further nodes, and a list comprising node elements of one type; deriving a set of commands relevant to the hierarchical object; receiving a string from a command line interface; parsing the string into a command in accordance with the relevant set of commands; and executing the command thus manipulating the hierarchical object by addition, deletion or modification of a member of the hierarchical object.

In accordance with yet another aspect of the disclosure there is thus provided a tangible computer program product, comprising a computer usable medium having a computer readable program code embodied therein, said computer readable program code adapted to be executed to implement a method for suggesting further applications to a user using an executed application in a computerized environment, said method comprising: receiving or creating a hierarchical object; automatically deriving a set of commands from the hierarchical object; receiving a string from a command line interlace; parsing the string into a command in accordance with the set of commands; and manipulating the hierarchical object by executing the command.

### BRIEF DESCRIPTION OF THE DRAWINGS

The present disclosure will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 is a schematic illustration of an object class hierarchy, for which a command line interface is provided, in accordance with the disclosure;

FIG. 2 is a flowchart of the main steps in a method for controlling an object through a command line interface, in accordance with the disclosure;

FIG. 3 is a schematic block diagram of the components required for constructing command line interface for hierarchical objects, in accordance with the disclosure; and

FIG. 4 is a schematic illustration of the commands or classes for providing command line interface for hierarchical objects, in accordance with the disclosure.

### DETAILED DESCRIPTION

An apparatus and method for providing infrastructure for a command line interface for configuring objects is provided. The command line interface is provided for objects derived from a known framework. The apparatus may be used for all such objects, and is particularly useful for hierarchical objects. In a hierarchical object some fields or members may be simple attributes that may be assigned a value, while at least one member is a list or another container, comprising further attributes, lists or containers.

An apparatus according to the disclosure receives the memory address of, or a pointer to an object, and provides a command line interface allowing a user to manipulate the object. Alternatively, the system creates a default object. The object, whether it is a pre-existing object or an object created by the apparatus, is then manipulated by the user through the command line interface. The user can change values of attribute members of the object, add elements to container members, delete elements from container members, set default values, or the like. When manipulation is done, the object can be used, or exported to a persistent storage, such as a hierarchical database such as LDAP.

One usage for the apparatus and system is for configuring objects controlling network devices, physical appliances, network appliances or applications. In such usage, a user, such as a person creating or maintaining a device network, creates multiple objects and configures each one of them according to a configuration required in the network, using the command line interface. Each configured object is then stored in a persistent storage. Later, when the actual devices are activated, a control object is created for each device and is loaded with the required configuration as retrieved from the storage.

The command line interface can be activated in an interactive mode in which it receives an object and lets an operator communicate with the object and manipulate its fields, or in a batch mode in which the command line interface reads a series of commands from a file and executes the commands.

The command line interface is implemented as one or more sets of interrelated computer instructions, such as an executable, static library, Dynamic Link Library (DLL), class library, web service, or the like. The command line interface can be implemented in any programming language such as C++, C#, Java or others, and under any development environment. The command line interface can be implemented in an object-oriented architecture, in a modular architecture, or the like. The command line interpreter is designed to be executed on any computing platform, such as a general purpose computer, a server, a personal computer, a mainframe computer, a server, a mobile device, or any other type of computing platform provisioned with a memory device, a CPU or microprocessor device, and I/O ports. Alternatively, the disclosure can be implemented as firmware ported for a specific processor such as digital signal processor (DSP) or microcontrollers, or can be implemented as hardware or configurable hardware such as field programmable gate array (FPGA) or application specific integrated circuit (ASIC).

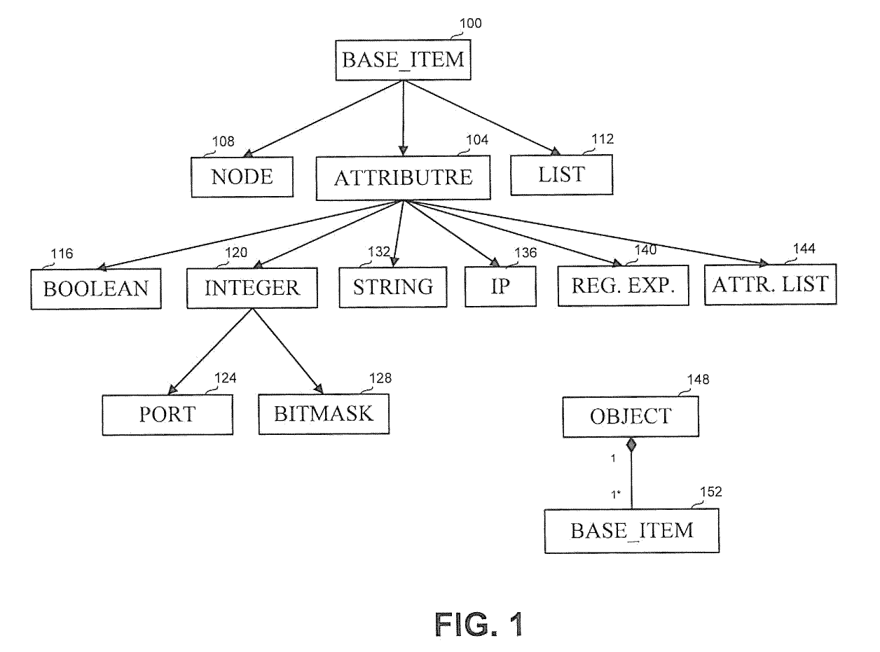

Referring now to FIG. 1, showing a schematic object class diagram of a specific hierarchy object repository. The disclosed command line interface is adapted to provide interface and enable configuration of objects whose members (also referred to as fields) are derived from any of the classes in the hierarchy.

At the base of the hierarchy, there is a base_item class 100. Base_item class 100 is inherited by attribute class 104, which implements a pair of name and value. Another class inheriting base_item 100 is node_item 108 which implements a collection of base_item objects or objects inheriting base_item. Node_item 108 maintains a static set or any other data structure of the items it contains, so the items can be traversed. Yet another class inheriting base_item 100 is list_item 112 which implements an ordered list of nodes. Similarly to the node_item, a field of type list_item keeps track of the nodes on its list, so as to enable traversal. Attribute_item class 104 is inherited by a number of classes, each implementing a particular value type, such as a Boolean attribute class 116, integer attribute class 120, string attribute class 132, IP attribute class 136, and regular expression attribute class 140. For example, IP attribute class 136 comprises a validity check that the value is of the form x,y,z,w, while x, y, z and w are between 0 and 255. Integer attribute class 320 is further inherited by port attribute class 124, and by bitmask attribute class 128, wherein the port number or the bitmask are implemented as integers with additional limitations.

Base_item 100 is also inherited by attribute_list class 144, which can handle multiple attributes of the same type. In some embodiments, the items may be separated by a predefined delimiter. For example, a list of space-delimited Attr_IP could be set with the value “10.1.1.1 10.1.1.2 10.1.1.3”. In order to remove one of the IPs, for example the value of “10.1.1.3”, the value of the attribute can be re-set to “10.1.1.1 10.1.1.2”. Manipulating an attribute list may include listing, adding an attribute, deleting an attribute, emptying the list, or the like.

Base_item 100 may implement a number of methods applicable to all objects, such as: “equal” for comparing two objects; name_set and name_get for setting and retrieving the object's name: class_name and instance_of for getting the name of the class and determining whether an object is of a particular type; clone_new for creating a new object and cloning the content of an existing one; clone_copy for cloning the copy of a first existing object into a second existing object; parent_set and parent_get for setting and getting the parent of a base_item object; key_get, key_set and key_equals for setting getting and comparing keys of objects; search and search_path for searching for a particular object within a list or node; is-valid for validating the integrity of an object; template get and template_set for defining initiated objects which can be used as a template for newly created object, and load and save methods. The load and save method receive as parameter a target, such as XML, string, memory, database and in particular a hierarchical database such as LDAP or the like. Each descendant object may override any one or more of the item_base methods, or avoid overriding them and use the base item's implementation. For example, a “save” method for an item_list generally traverses the list and calls “save” for each item in the list.

When a new class is defined and objects are created as instances of the class, such as object 148, it is optionally defined to contain members 152 of the various classes shown above that inherit item_base. For example, a Network class may contain a member of string_attribute type which may be named “host name” and is assigned a value of the host name, a member of type IP_attribute having an IP address as value, a member of type list which contains multiple elements of type IP_attribute, or the like. The members are registered with the class, so that the class is aware of its members and can iterate over them.

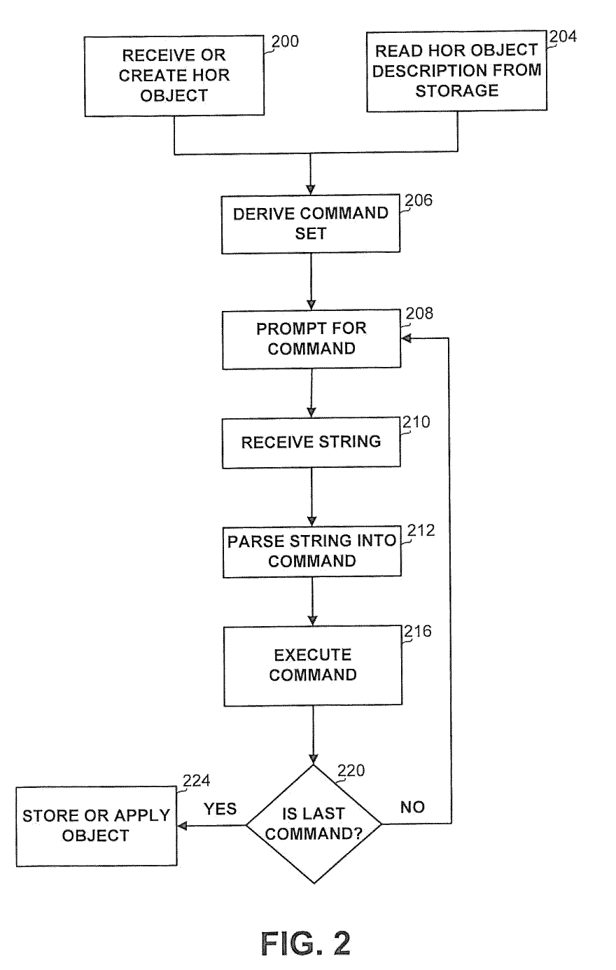

Referring now to FIG. 2, showing a flowchart of the main steps in a method for controlling an object through a command line interface.

On step 200, a hierarchical object of a known type is received or created. If the object is created, its fields are assigned default values. Alternatively, on step 204 a pre-stored object description is read from a database or another persistent storage, and an object is created and the members are assigned the values retrieved from the storage.

On step 206 a relevant set of commands is automatically derived for the hierarchical object. Some commands are constant and are not affected by the object, while others, such as commands for drilling into a sub object or parameters of some commands are related to the specific hierarchical object and its structure. Deriving the commands is enabled by the self-awareness of the object, and its ability to list its members and traverse them, and recursively repeat the listing and traversing.

On optional step 208, the system may prompt a user for a command, using a user interface, and remain in idle mode, waiting for commands to be input by a user. This step is omitted in batch mode in which the next command is read from a file.

On step 210, a string such as a textual string is received from a user or read from an input file, and on step 212 the string is parsed into a command, with optional parameters and optional flags. The command is in accordance with the command set derived on step 206, otherwise it cannot be executed and an indication is optionally provided to a user if the system is in interactive mode.

On step 216 the command is executed. Some commands may cause the manipulation the object, such as addition, deletion or alteration of members. Other commands such as show or traversal commands use the object but do not alter it, while others do not require the object, such as help, quit, or the like.

On step 220 it is determined whether the command received on step 212 is a command ending the session, such as a “Quit”, “Exit” or the like. If it is, then, on optional step 224 the changes are optionally stored in a persistent storage such as a database, a hierarchic database, or the like, and then the process ends. Otherwise, the method goes back to step 208 and prompts the user for another command, or reads another command from a file.

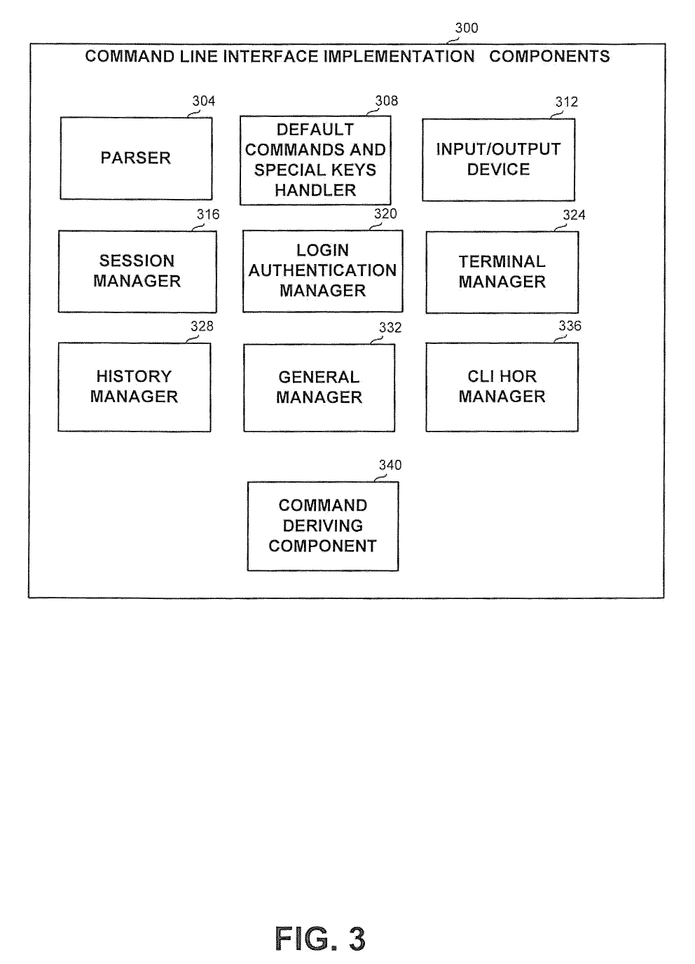

Referring now to FIG. 3, showing the basic components implemented for generating a command line, interface program that receives or creates an object and enables the manipulation and configuration of the object. The disclosure relates to an object-oriented implementation of the interface. However, it will be appreciated by a person skilled in the art that the interface can be implemented using any other methodology which enables the implementation of the disclosed functionality, and is not limited to object-oriented implementation.

The classes to be implemented include parser classes 304, designed to receive a text string and parse it. If parsing is successful the string is parsed into a command, parameters if required for the command, and optional flags for the command.

Another required component is default commands and special keys handler 308, for implementing default commands common in CLI systems. The commands optionally include but are not limited to the following: a “help” command which provides a user with a list of all available commands at the current state, wherein each command is optionally accompanied by a brief explanation; a “quit” command for quitting the program, if the user changed values of fields in the object, the quit command optionally invokes a question whether the user wishes to save the changes; an “exit” command for exiting the current CLI level and returning to the previous level (in case the user has changed the state and is working on a sub-field of the original object). Special keys handler optionally support commonly accepted special keys which enhance the efficiency of the users. Such special keys optionally include but are not limited to the: Clearline, which may be implemented as Ctrl-k, clears the input line of text; End of Line (EOL) which may be implemented as Ctrl-e, sets the text cursor to the end of the current line; Up or Down arrow keys enable the traversal through, and repetition of previously entered commands according to the order at which they were issued.

Yet another component is input/output device controller component 312 responsible for sending output characters or lines to the user's display device, and receiving lines from the device, such as a screen, a printer, a text to speech vocal device, a file, or the like. The output device class can also enable a user to control the output, for example by stopping the listing and showing a specific character or string when the output length exceeds a predetermined number of lines.

Session manager component 316 is responsible for managing the CLI application. The CLI optionally has two main modes of operation: an interactive mode, in which an application, such as a daemon (a computer program that runs in the background), a servlet (a process that requests and constructs responses), an interactive daemon (a computer program that can be accessed by a user) or the like, is activated and to which a user can connect. The application creates a device appliance object or connects to an existing one, optionally loads a configuration, and executes the application's event loop, i.e., receives and executes commands. The second mode is batch or file processing mode, in which the input commands are read from a file and are processed one by one, and not received interactively from a user.

Login authentication manager class 320 is responsible for handling the login state, machine authentication and password management of the users. In some embodiments, a login sequence is to be performed, in which the user connects to the application such as the CLI daemon using a remote client such as a TELNET client, thus initiating a session. Before the user can perform the restricted operations via the CLI, he or she is required to authenticate, optionally using a password.

Terminal manager class 324 handles the input and output streams to and from another computing platform which connects to the platform executing the CLI, such as TELNET clients.

History manager class 328 is responsible for managing the list of previous commands entered by the user, for repeating previous commands, editing previous commands, going through the command list using the arrow keys as described above, or the like.

Yet another class is general manager class 332 designed for deriving the command set relevant for the object, and optionally supporting additional operations, such as automatic completion of commands, listing commands according to the session context, or the like.

The command line interface of the disclosure is designed to receive and manipulate objects of a known structure or framework. In the particular exemplary embodiment, the objects for which the interface can be used, are objects whose fields or members are of class types belonging to the class hierarchy disclosed in association with FIG. 1 above, or class types derived from these classes.

Therefore, a component implemented as part of the CLI is CLI HOR manager 336. CLI HOR manager 336 enables the persistency, i.e., creating or loading a hierarchical object from a persistent storage, and storing an object in the storage. When the object is in memory, CLI HOR manager 336 enables the execution of the object manipulation commands, i.e., altering the object's properties in memory by constructing an appropriate interface for receiving commands and executing the provided commands. In addition the HOR manager classes supply facilities such as displaying the current configuration of an object residing in memory.

A further component is command deriver component 340 for deriving a set of commands, based on default commands and on the particular object as initially created or loaded.

It will be appreciated that multiple implementations are possible for the disclosed components, and that the description is functional rather than structural. In some object-oriented embodiments, the implementation of a component can be distributed between one or more classes, while multiple components can be partially or fully implemented by one class.

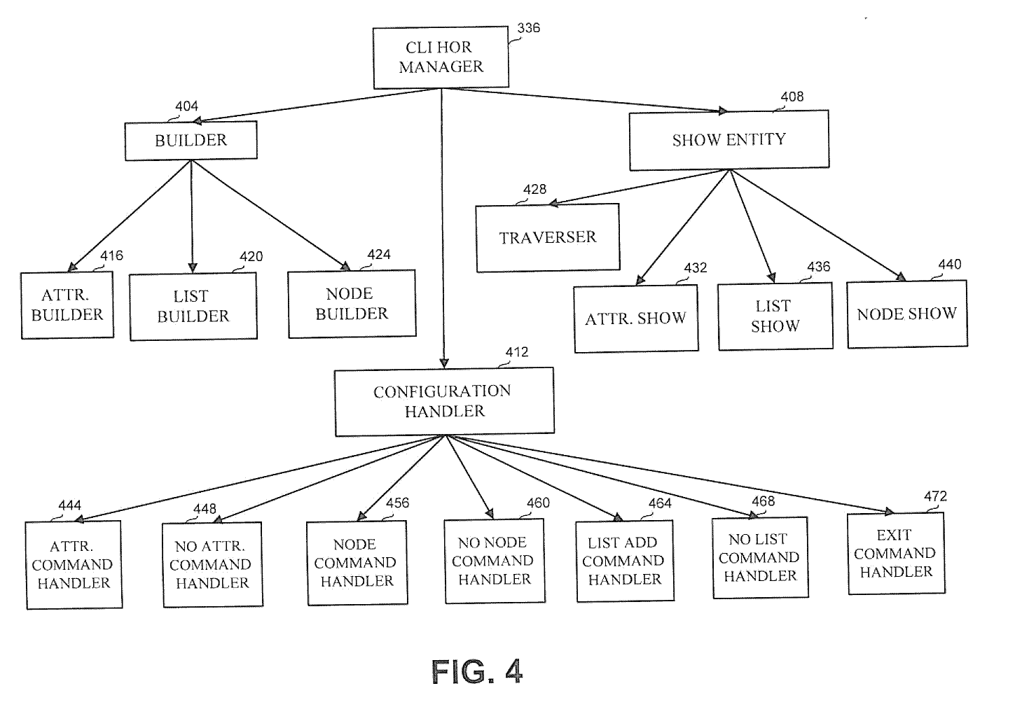

Referring now to FIG. 4, showing a schematic illustration of the commands or classes providing the manipulation functionality associated with CLI HOR manager component 336.

The objects manipulated by CLI HOR manager class have a member, or are otherwise associated with an object of base_item 100 of FIG. 1, or of a class derived from base_item 100, which contains one or more members of class base-item or of classes that inherit base-item 100. The base object optionally represents the entity to be configured, such as the remote appliance.

It will be appreciated by a person skilled in the art that FIG. 4 is not necessarily a class diagram and links in FIG. 4 do not necessarily indicate inheritance, but rather any type of association. Such association may be implemented in a multiplicity of ways, such as containing or pointing at another object having relevant method, friend methods, global methods and variables, and even non-object-oriented technologies, such as procedural programming.

CLI HOR Manager 336 is thus associated with build entities 404, which may be implemented as classes, methods, handlers, functions or the like for constructing elements of a HOR object; show entities 408 which may also be implemented as methods, handlers, functions or the like, for displaying the contents of an HOR object or a sub-object thereof; and configuration entities 412 which may also be implemented as methods, handlers, functions or the like for manipulating an HOR object.

Build entities 404 are designed to construct an instance of an attribute, node, or list classes of the HOR hierarchy, and optionally add the instance to the objects contained in an object of node class 108 or list class 112. Builder entity 404 calls, overrides, or otherwise accesses attribute builder method 416 which is designed to receive an attribute name and value, and create an attribute under the current “parent” node having the attribute name with the provided value.

Builder entity 404 can also access list builder entity 420. List builder entity 420 receives a list name and type, and constructs an instance of list type 112 having the list name, and objects of the given type. Similarly, Node builder entity 424 receives a node name, and constructs an instance of node type 108 having the node name.

Show entity 408 calls, overrides, or otherwise accesses traverser functionality 428, implemented as a method, a function or the like, which traverses the items associated with the objects, so that a relevant show method, function, routine or the like can be called for each of them. If any of the objects is a node or a list, the traverse function is called recursively for the node or list.

In order to show an attribute object, attribute show entity, method or function 432 is called, which lists the attribute name and value.

In order to show a list object, list show entity 436 is called, which calls traverser 428 and then calls the relevant show entity for each element of the list.

In order to show a node object, node show entity 440 is called, which calls traverser 428 and then calls the relevant show entity for each item within the node.

In order to show or manipulate the elements of a sub-object, such as a node or a node within a list within the object, the user may have to “descend”, drill, or go into the level of the particular sub-object. This can be done by traversing down into a sub-node's level. It will be appreciated that the hierarchy shown in FIG. 4 is not a mapping of all element hierarchy and command set, but rather provides a representation of the command set required for node manipulation. The levels may be implemented as a stack-like data structure representing the nodes only. Thus, the stack initially starts at the level representing the parent object, such as the object representing the appliance to be configured. By executing node command handler or list add command handler detailed below, the respective level is added to the stack and becomes the current context.

Configuration handler entity 412 enables the manipulation of an object of a class from the HOR hierarchy or derived therefrom. Configuration handler entity 412 supports, calls or otherwise accesses attribute command handler 444 which receives an attribute name and value, and sets an attribute under the current object having the attribute name to the provided value.

No attribute command handler 448 receives an attribute name, and sets the attribute having the same name to its default value.

Node command handler 456 receives a node name, and changes the current state or level of the object to point into the level of sub-node having the node name under the current object. Once inside the node, the node's items can be traversed, attributes can be changed, lists can be manipulated, items can be added, and the level can go into further nodes.

No node command handler 460 receives a node name, and changes the node to its default value.

Node command handler 456 enables the user to move within the object into sub-nodes and explore or change them. By running “exit” the user can move back to higher levels of the object.

List add command handler 464 receives an existing list name, and a new object name, creates an object of the same type as all objects within the list, the object having the new object name, and adds the object to the list having the existing list name. For example, if a list named “appliance-list” exists under the current level, and it is required to add to the list a new node named “my_device”, then a command is run “appliance-list my_device”. The new object will be added, and the level is changed so that it represents my_device node. Once inside the child node, its items can be traversed, attributes can be changed, lists can be manipulated, items can be added, and the current state can go into further nodes or lists. Executing an “exit” command will exit the list child-node level back to the level of which the list is a member.

No list command handler 468 receives a list name and child name and removes the child from the list. For example “no appliance-list my_device” will erase my_device without any additional effects.

Exit command handier 472 exits from the current node or list one level back.

It will be appreciated that the disclosed set of commands enables manipulations of objects of the HOR hierarchy. However, in some implementations, not all commands have to be implemented. Rather the exact implementation depends on the specific system. For example, if a node is of a constant structure has two attributes of known types and three lists, then node add command is not supported.

The disclosed method and apparatus provide infrastructure for enabling a command line interface for objects of known types, and in particular to hierarchical objects whose elements and collections are of known types.

The command line interface enables the configuration of objects controlling physical entities, such as remote appliances. An object can be configured and stored in a persistent storage device. Then when it is required to configure a physical device, the configuration is retrieved and used for configuring the device.

It will be appreciated that the description is not limited to providing textual command line interfaces. Rather, other interfaces such as graphic interfaces can be provided based on the same principles, by integrating graphic user interface components into the system.

It will be appreciated by a person skilled in the art that the disclosed apparatus is exemplary only and that multiple other implementations can be designed without deviating from the disclosure. Any component of the apparatus can be implemented using proprietary, commercial or third party products.

It will be appreciated by persons skilled in the art that the present disclosure is not limited to what has been particularly shown and described hereinabove. Rather the scope of the present disclosure is defined only by the claims which follow.

What is claimed is:

1. A method for manipulating a hierarchical object, comprising:
receiving or creating a hierarchical object;
deriving a set of commands relevant to the hierarchical object;
receiving a string from a command line interface;
parsing the string into a command in accordance with the relevant set of commands; and
executing the command thus manipulating the hierarchical object.

2. The method of claim 1 wherein the hierarchical object controls a configuration of a network appliance.

3. The method of claim 1 wherein the hierarchical object controls a configuration of a physical device.

4. The method of claim 1 wherein the hierarchical object controls a configuration of an application.

5. The method of claim 1 further comprising retrieving from a storage device a description of the hierarchical object or storing in a storage device a description of the manipulated hierarchical object.

6. The method of claim 1 wherein the hierarchical object has members of types selected from the group consisting of: an attribute, a node wherein a node comprises further nodes or attributes, and a list comprises node elements of one type.

7. The method of claim 1 wherein the command for manipulating the hierarchical object enables addition, deletion or modification of a member of the hierarchical object.

8. The method of claim 1 wherein the command for manipulating the hierarchical object enables drilling down into a sub-object of the hierarchical object.

9. An apparatus for manipulating a hierarchical object, comprising components executed by a computing platform, the apparatus comprising:
a command line interface manager for creating or loading the hierarchical object;
a command deriving component for automatically deriving a set of commands, based on the hierarchical object;
an input/output device controller for receiving input from an input device and sending output to an output device;
a parser for parsing the command;
a hierarchy object manager component for manipulating the hierarchical object by executing the command; and
a session manager for managing an interactive or batch session of the apparatus in which the hierarchical object is manipulated.

10. The apparatus of claim 9 wherein the hierarchical object controls a configuration of a network appliance, a configuration of a physical device, or a configuration of an application.

11. The apparatus of claim 9 further comprising a default commands and special keys handier for implementing default commands.

12. The apparatus of claim 9 further comprising a history manager for storing and manipulating previous commands entered by a user of the apparatus.

13. The apparatus of claim 9 further comprising a terminal manager for receiving and sending input and output streams to and from a second computing platform which connects to the computing platform.

14. The apparatus of claim 9 further comprising a login authentication manager for managing machine authentication, login state of a user, and password management of a user.

15. The apparatus of claim 9 further comprising a general manager for providing automatic completion of commands, or listing commands according to a context.

16. A method for manipulating a hierarchical object, comprising:
receiving or creating a hierarchical object controlling the configuration of a physical device, the configuration of a network appliance, or the configuration of an application, the hierarchical object comprising members of types selected from the group consisting of: an attribute, a node wherein a node comprises further nodes, and a list, comprising node elements of one type;
deriving a set of commands relevant to the hierarchical object;
receiving a string from a command line interface;
parsing the string into a command in accordance with the relevant set of commands; and
executing the command thus manipulating the hierarchical object by addition, deletion or modification of a member of the hierarchical object.

17. A tangible computer program product, comprising a computer usable medium having a computer readable program code embodied therein, said computer readable program code adapted to be executed to implement a method for suggesting further applications to a user using an executed application in a computerized environment, said method comprising:
receiving or creating a hierarchical object;
automatically deriving a set of commands from the hierarchical object;
receiving a string from a command line interface;
parsing the string into a command in accordance with the set of commands; and
manipulating the hierarchical object, by executing the command.
